(19) United States
(12) Patent Application Publication
(10) Pub. No.: US 2010/0319470 A1
(43) Pub. Date: Dec. 23, 2010

(54) Sensor configuration without housing

(75) Inventors: Wolfgang Wehrle, Konstanz (DE); Alexander Juergens, Frauenfeld (CH)

Correspondence Address: DeMont & Breyer, LLC, 100 Commons Way, Ste. 250, Holmdel, NJ, 07733, US

(73) Assignee: BAUMER INNOTEC AG, Frauenfeld (CH)

(21) Appl. No.: 12/816,791

(22) Filed: Jun. 16, 2010

(30) Foreign Application Priority Data
Jun. 19, 2009 (DE) 10 2009 029 939.4

(51) Int. Cl. G01D 7/00; B32B 37/24; B23K 31/02

(52) U.S. Cl. 73/866.1; 156/245; 228/176

(57) ABSTRACT

The present invention relates to a method for manufacturing a housing-less sensor, in particular a proximity sensor. Here it is proposed to build all of the components needed for the mechanical and electrical functions on one sensor chassis and then to inject a plastic compound around the components.

### FIELD OF THE INVENTION

The present invention relates to a method for manufacturing electronic sensors, in particular, for the packaging of sensors, as well as to the sensors manufactured with the method.

### BACKGROUND OF THE INVENTION

Electronic sensors are generally used for the quantitative and/or qualitative detection of physical measurement variables from their surroundings, wherein the detected measurement variables are converted into electrical signals and transmitted for further processing. In principle, active and passive sensors can be distinguished, wherein active sensors comprise, in addition to an actual transducer, additional primary electronics and are powered with external auxiliary energy. As examples for such electronic sensors, inductive or capacitive proximity switches, magnetic sensors, light sensors, light barriers, optical fiber sensors, inductive distance sensors, triangulation distance sensors, and phase-measuring optical distance sensors are to be named in a non-exhaustive list.

As a rule, the technological configuration of such sensors comprises a robust housing that contains a transducer and corresponding electronics on a printed circuit board, wherein contacts of the sensor electronics are guided outward through the housing. Possible sensor structures that have become established on the market include sensors with both cylindrical and also polygonal housing types. The housings are usually preassembled from metal or plastic, so that the transducer, the sensor electronics, and also the contacts, for example, in the form of a cable or a plug contact, can be installed in these housings. Usually, the components of a sensor installed in the housing are encapsulated in casting compounds for protection from environmental effects and for mechanical stabilization of the sensor structure.

Each transducer can be made both from an individual electronic, electromechanical, or optoelectronic component and also from a preassembled group of electronic, mechanical, and/or optical components.

In the scope of the present invention, a polygonal sensor structure is understood as a sensor with a generally polyhedral housing body that usually has essentially the shape of a block or several blocks nested one inside the other. Corresponding polygonal structures are suitable in an especially advantageous way for assembly in T-grooves of profile systems that are very common, for example, in the field of special machine construction. In principle, polygonal sensors could also be mounted on arbitrary support elements for systems or machines.

A disadvantage relative to cylindrical sensor structures is the complex milling for the metal or plastic housing of the polygonal sensors, whose production is relatively cost-intensive. Alternatively, the housings of polygonal sensors can be produced from zinc diecast material, wherein the problem of the expensive housing is shifted to high initial costs for the casting mold. With respect to small quantities, the problem of high production costs and limited flexibility remains for polygonal sensor structures.

Another disadvantage of a polygonal sensor structure is that these sensors must be mounted on a flat surface of a machine or system housing with at least two attachment screws, which represents increased complexity relative to cylindrical sensors.

A so-called “housing-less” sensor represents another structure whose electronic components contact each other mechanically so that they can move relative to each other initially in the production process before they are placed in an injection mold and held there by means of fixing elements in a fixed, predetermined position. A plastic compound is then injection molded completely around the components, wherein a molded body is formed from the plastic compound whose outer dimensions correspond to the inner dimensions of the injection mold.

A disadvantage in this method is that the individual components, such as the transducer of a sensor, a printed circuit board with the primary electronics and the contacts, must be placed and fixed in the injection mold in a complicated and precise way. In addition, fasteners must be provided on the molded body of a housing-less, polygonal sensor in order to be able to mount these fasteners at their position of use. The fasteners constructed as threaded inserts, threaded through-holes, or threaded posts likewise must be placed and fixed in the corresponding mold before the injection molding.

### SUMMARY OF THE INVENTION

Therefore the invention is based on the problem of disclosing a sensor that can be produced, in particular, in small quantities with low production costs and that offers additional mounting benefits for the customers.

The present invention comprises a production method for a sensor, wherein by injection molding of a plastic compound around a number of components, a molded body, for example, with a polygonal shape, is formed, whose outer dimensions correspond to the inner dimensions of an injection mold. The components can be, in general, any optical, electronic, mechanical, and/or hybrid-integrated components that are required for the function and handling or assembly of each sensor. In particular, these components include a transducer constructed for each measurement task. In a first step, the optical, electronic, and/or mechanical components of the sensor are fixed mechanically on a top side and/or back side of a printed circuit board. In another step, the equipped printed circuit board is placed in the injection mold. In the injection mold, the printed circuit board is held in a defined position relative to the walls of the injection mold by means of support fingers. Then the plastic compound is injected in a fluid state into the injection mold, so that the printed circuit board with the components is injection molded at least partially in this fixed position.

A transducer is preferably constructed as a hybrid-integrated component that comprises, for its part, corresponding to each measurement task, a number of electronic, mechanical, and/or optical components, and thus forms, with respect to the printed circuit board assembly, an individual, prefabricated component.

If necessary, it can be desirable that the transducer is not covered by the plastic compound or is not completely embedded in the plastic compound. This can be the case, for example, for optical sensors, when the beam path should not be realized through the casting compound up to the optical sensor. For this purpose, in a refinement of the invention, it is provided to embed a duct element in the plastic compound, wherein this duct element forms a duct in the plastic compound. The transducer is here arranged in the duct. The duct element is mounted on the circuit board before the injection molding with the plastic compound, so that, considered in a top view of the circuit board, the duct wall surrounds the transducer. When injecting the plastic, the plastic compound does not or at least does not completely penetrate into the duct interior, so that the duct remains free from the plastic compound or so that, after the injection, the plastic compound surrounds a duct formed by the duct element. For this purpose, in general it is favorable to mount the duct element in a sealing manner on the circuit board, so that penetration of the plastic compound between the end of the duct element pointing toward the circuit board and the circuit board itself is prevented during the injection molding. Then other elements could also be arranged in the duct. For example, the duct could be closed for sealing with a window made from suitable material or an optical element.

In a different, likewise preferred embodiment or refinement of the invention, a transducer of an optical sensor could comprise an optoelectronic component fixed mechanically on the printed circuit board, as well as a preassembled lens unit with a lens carrier and at least one lens. The lens carrier can be placed in a groove of the printed circuit board and in the injection mold and at least partially injection molded. Here, the lens carrier advantageously forms a duct in the plastic compound as mentioned above.

This two-part or multiple-part structure of an optical transducer allows the use of an optoelectronic standard component, e.g., a photodiode and application-specific optics, so that a special, preassembled, hybrid-integrated component can be eliminated.

By pressing the lens carrier during the injection molding, it is prevented that still-fluid plastic compound can penetrate between the printed circuit board or between the optoelectronic component and the optics and thus block the optical beam path of the transducer. The lens carrier is preferably injection molded only around its sides that are perpendicular to the printed circuit board, so that the outer side of the lens carrier facing away from the optoelectronic component can be sealed essentially flush with the plastic molded body of the sensor.

In comparison with prior art, the method according to the invention allows the production of a “housing-less,” for example, polygonal sensor, wherein a printed circuit board that is usually already required for the primary electronics can be used simultaneously as a chassis, i.e., as a mounting platform for the mechanical sensor structure.

The mechanical components comprise at least one attachment element that is provided for the attachment of the sensor. As such an attachment element, a threaded insert or a threaded sleeve could be clipped in the printed circuit board, wherein this insert or sleeve is completely or at least partially injection molded with the plastic compound in the injection-molding process. Thus, a non-positive-fit connection and a positive-fit connection are created between the attachment element and the molded body of a sensor, whereby the forces occurring during assembly of the sensor are absorbed optimally distributed in the molded body.

It is especially advantageous that the electronic and the mechanical components can be placed on the printed circuit board with a pick-and-place technique that is common in electronics engineering and can be fixed on the printed circuit board with typical attachment processes, such as clipping, bonding, and/or soldering. A sensor chassis can thus be equipped with all of the components in a conventional automatic pick-and-place device.

One particularly advantageous refinement of the invention is a printed-circuit-board panel that comprises a number of usually identical printed circuit boards that are injection molded in the injection mold simultaneously to form the panel with the plastic compound. With a complete or also half of a circuit-board-plate panel as a mounting platform, a corresponding number of sensors can be provided simultaneously with an injection-molded housing that is, for example, polygonal. The individual sensors are then separated from the printed-circuit-board panel.

Another construction of the invention provides that the equipped circuit board of each sensor be injection molded with a transparent or semi-transparent plastic compound. Therefore it is possible to apply labeling for the sensor, e.g., models and/or connection markings, directly onto the printed circuit board, wherein this labeling remains visible through the transparent molded body of the sensor. Thus, in an especially advantageous way, the printing of additional labeling on the surface of the molded body can be eliminated.

The invention likewise comprises a housing-less, for example, polygonal sensor that can be produced with the method according to the invention. Such a sensor comprises a printed circuit board on whose top side and/or back side, mechanical and electronic components are mounted, wherein the printed circuit board and the mechanical components are surrounded by a molded body made from plastic, wherein the molded body can have, in one refinement of the invention, for example, a polygonal shape. All of the components, including the transducer that is constructed as a coil, e.g., for an inductive proximity sensor, are thus arranged directly on the flat printed circuit board.

Among the mechanical components on the printed circuit board, at least one attachment element is provided that could be constructed as a threaded insert.

Many sensor structures, in particular, also polygonal shapes, should usually have at least two screw connections with which each sensor housing is mounted on a machine or system part. Preferably, additional alignment pins that are used for the exact positioning of the sensor are provided on a mounting/back side of the molded body of a sensor according to the invention, so that a second screw connection for mounting can be eliminated. Thus, on the user side, only one borehole on a machine or system is needed. The alignment pins are preferably constructed so that they can be easily removed, so that they can be easily broken away or cut off during assembly.

As an alternative to the threaded insert, the sensor could be constructed on the back side with a threaded sleeve that can be used simultaneously as a sensor attachment and for realizing the electrical connections. Thus, the sensor connection can be transferred in an especially advantageous way into a protected machine or system part.

In one preferred embodiment, the molded body of the sensor is constructed from a transparent or semi-transparent plastic. Therefore, sensor labeling on the printed circuit board is possible and does not have to be applied onto the surface of the molded body in an extra step. In addition, a light-emitting diode or another display element could be arranged and used as a function display for the sensor. The display element can be placed by machine during the sensor production and is visible without additional components, such as optical fibers or transparent cover films, at a large angle through the transparent or semi-transparent molded body of the sensor.

### BRIEF DESCRIPTION OF THE DRAWINGS

These and other features, as well as other associated advantages of the invention result from the following detailed description of preferred embodiments with respect to the accompanying drawings. Shown in the drawings are:

FIG. 1: a housing-less, inductive proximity sensor with a polygonal housing and an encapsulated threaded insert.

FIG. 2: a housing-less, inductive proximity sensor with a polygonal housing and a threaded sleeve arranged on the back side.

FIG. 3: a housing-less, optical proximity sensor with a polygonal housing and an optical transducer.

### DETAILED DESCRIPTION

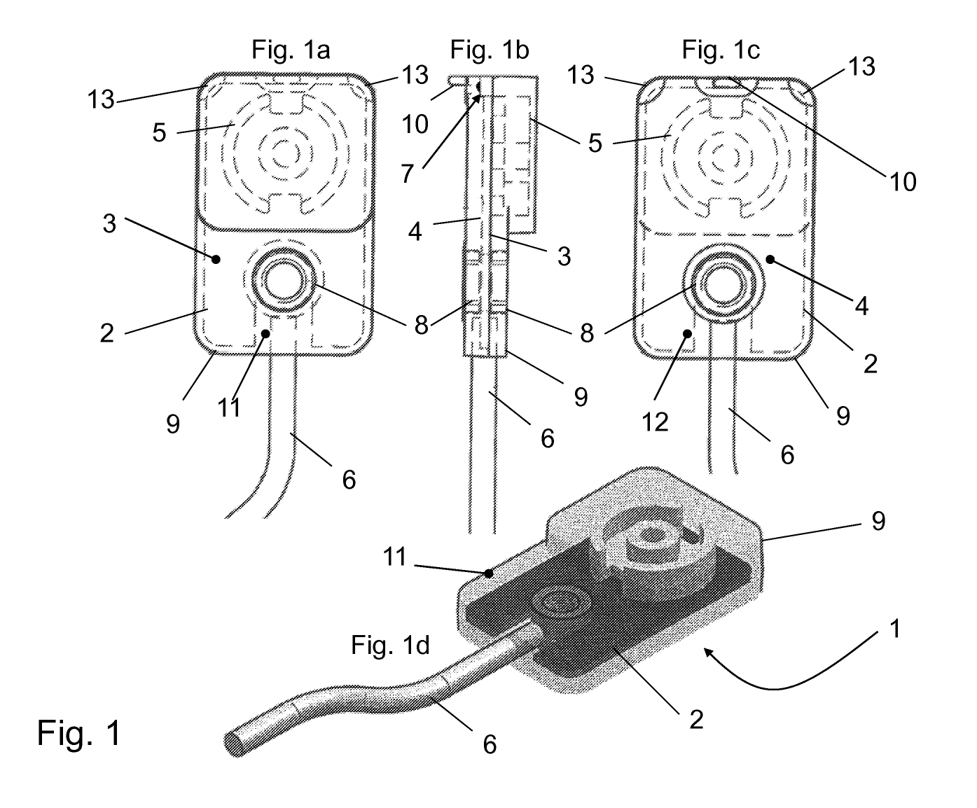

FIG. 1 shows an inductive proximity sensor in a polygonal sensor structure with a threaded insert that is used for mounting the sensor at a provided position for use. Instead of the threaded insert, a thread-less through-hole for a screw or rivet connection could also be provided at this position.

The sensor 1 comprises a printed circuit board 2 that has been equipped by hand or preferably with an automatic pick-and-place system, wherein the components can be placed both on the top side 3 and also on the back side 4 of the printed circuit board 2. The surfaces of the printed circuit board are provided with typical track conductors for the contacts of a transducer 5 that essentially comprises, in the present example, a coil for the connection cable 6 and the light-emitting diode 7 that are not shown explicitly in the present drawing.

In addition to the typical contact holes of a printed circuit board that can be used for making contacts for the coil 5 and connection cable 6, the printed circuit board contains additional assembly openings through which or in which the different components can be guided or mounted with an expanding rivet connection. The relevant components can be additionally or alternatively mounted on the printed circuit board by adhesive or solder connections.

A threaded insert 8 is guided through an opening in the printed circuit board and is used for the later housing of an attachment screw for the assembly of the sensor. The threaded insert can have a one-part or two-part construction and can be clipped, riveted, adhered, and/or soldered to the printed circuit board. In addition, a tension-reducing device not shown in detail for the connection cable 6 could be integrated on the threaded insert 8. If necessary, the connection cable 6 could also be fixed on the printed circuit board by means of an additional clamping device that is likewise not shown in the drawing.

The printed circuit board is enclosed by a molded body 9 made from plastic that can be produced in an injection molding process. The connection cable 6 is here guided through one end face out from the essentially block-shaped molded body 9.

The top side 11 of the molded body 9 has, in the region of the coil 5 constructed upward, a greater distance to the printed circuit board, in order to completely enclose the coil. The threaded insert 8 forms a flush seal with the surfaces on the top side 11 and bottom side 12 of the molded body 9.

An additional alignment pin 10 that can be used for the exact positioning of the sensor during its assembly is provided on the back side 12 of the molded body 9. The alignment pin 10 is constructed such that it can be easily removed by breaking or cutting it off if it is not needed.

The molded body 9 has, on its top side 11 and also on its bottom side 12, recesses 13 in which the printed circuit board 2 has been held by support fingers of the injection mold during the injection molding.

A light-emitting diode 7 provided on the back side of the printed circuit board can be easily seen, even from the top side, through a transparent or semi-transparent molded body of the sensor.

In addition to the coil for an inductive proximity sensor, a sensor shown in the figure could also comprise an electrode arrangement as a transducer 5 with which, e.g., capacitive proximity sensors can be realized.

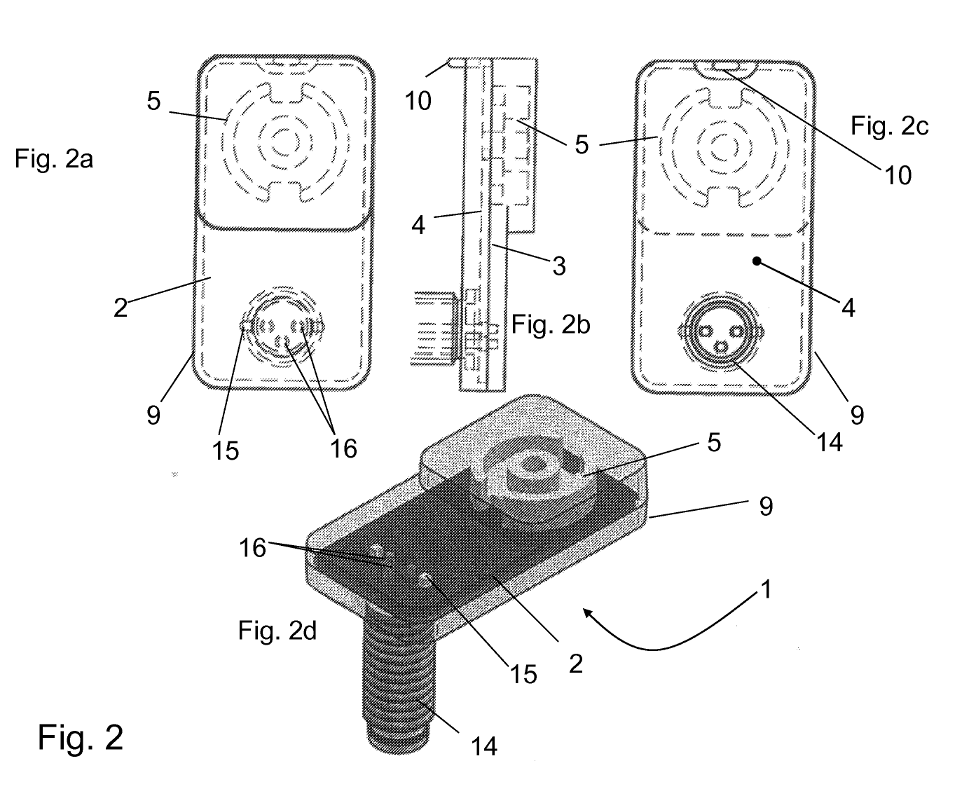

FIG. 2 shows another embodiment of an inductive proximity sensor, wherein the basic structure is essentially identical to the sensor described above.

The essential difference consists in the device for attaching the sensor, wherein, in the present case, this device is provided as an attachment sleeve 14 on the bottom side 12 of the molded body 9.

The attachment sleeve 14 is provided with two locking pegs 15 that are guided through corresponding openings from the back side 4 through the printed circuit board 2. The electrical connection of the sensor is preferably provided by means of the attachment sleeve 14, wherein, for example, a connection cable is guided through the interior of the attachment sleeve 14. Alternatively, a plug contact could also be provided in the attachment sleeve 14. The electrical connections to the track conductors not shown further on the top side 3 of the circuit board 2 are provided by contact legs 16 that are guided through corresponding contact holes from the back side 4 through the printed circuit board and are soldered on the top side 3 to the track conductors.

This construction is especially advantageous, in order to guide the sensor connection through a housing wall into a protected machine part.

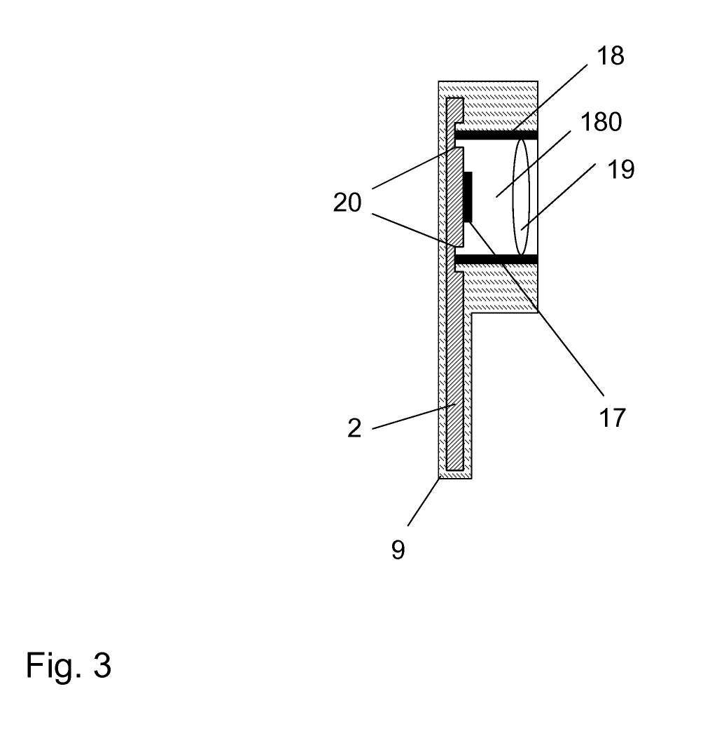

FIG. 3 illustrates another embodiment of the present invention and shows an optical sensor.

The sensor 1 comprises, in turn, a printed circuit board 2 that has been equipped with the transducer 5 and other mechanical and electronic components that have not been shown in detail repeatedly. For mounting such a sensor, as shown in FIGS. 1 and 2, both the threaded inserts 8 and also the attachment sleeves 14 can be used.

The transducer 5 comprises, e.g., a photodiode 17 or another optoelectronic component that is soldered onto the printed circuit board 2. The electric contacts of the photodiode 17 are preferably realized via the back side 4 of the printed circuit board 2, wherein via contacts are used that are not shown in the drawing and that are known to someone skilled in the art of printed circuit board engineering.

The transducer also comprises a lens unit that includes a lens carrier 18 and at least one lens 19. The lens carrier has the shape of a tube that is embedded after the injection of the plastic and defines a duct 180 in the plastic compound whose inner duct wall surrounds the transducer. The lens unit thus represents a preassembled optical component that is placed above the photodiode 17 in a groove 20 on the printed circuit board 2 before the injection molding.

With corresponding support points in the not-shown injection mold, the groove 20 guarantees mechanically sufficient fixing of the lens unit. Through a suitable contact pressure, a sufficient seal is guaranteed and thus a penetration of the plastic compound between the printed circuit board 2 and the lens carrier 18 is prevented.

What is claimed is:

1. A method for the production of at least one sensor, wherein through the at least partial injection molding of a plastic compound around components that comprise optical, electronic, mechanical, and/or hybrid components, but at least one transducer, an polygonal molded body is formed whose outer dimensions correspond to the inner dimensions of an injection mold,
characterized by:
mechanically fixing the components before the injection molding on a top side and/or back side of at least one printed circuit board;
placing the at least one printed circuit board equipped with the components into the injection mold;
holding the at least one printed circuit board in the injection mold in a defined position relative to the walls of the injection mold by means of support fingers; and
injection molding the at least one printed circuit board with the components in the defined position.

2. The method according to claim 1, wherein the components are placed, pressed, clipped, adhered, or soldered onto the printed circuit board.

3. The method according to claim 1, wherein, as a transducer, a preassembled, hybrid-integrated component i) is fixed mechanically on the printed circuit board, ii) comprises the optical, electronic, and/or mechanical component and iii) is at least partially injection molded.

4. The method according to claim 4, further comprising mounting a duct element on the printed circuit board before the injection molding with the plastic compound, so that, in a top view of the printed circuit board, a duct wall surrounds the transducer, so that, after the injection molding, the plastic compound surrounds a duct formed by the duct element.

5. The method according to claim 1, wherein, as a transducer, the sensor comprises an optoelectronic component fixed mechanically on the printed circuit board, as well as a preassembled lens unit with a lens carrier and at least one lens, wherein the lens carrier is placed in a groove of the printed circuit board and in the injection mold and is at least partially injection molded.

6. The method according to claim 1, wherein the mechanical components comprise at least one attachment element that is injection molded at least partially with the plastic, so that a mechanically rigid connection to the molded body is formed.

7. The method according to claim 1, wherein the printed circuit board is assembled with multiple identical printed circuit boards to form a printed circuit board panel, the printed circuit boards in the printed circuit board panel are placed in the injection mold and injection molded, and after the injection molding, the encapsulated printed circuit boards are separated from the printed circuit board panel.

8. The method according to claim 1, wherein a transparent or semitransparent plastic is used as the plastic compound.

9. A sensor manufactured according to the method of claim 1, wherein the sensor comprises a printed circuit board on whose top side and/or back side, at least one optical, mechanical, electronic, and/or hybrid-integrated component is mounted, wherein the printed circuit board and the components are at least partially surrounded by a molded body made from plastic.

10. The sensor according to claim 9, wherein the components comprise at least one transducer that is constructed as an electronic, mechanical, and/or hybrid-integrated component.

11. The sensor according to claim 9, further comprising a duct element that is embedded in the plastic compound and that forms a duct in the plastic compound, and wherein the transducer is arranged in the duct.

12. The sensor according to claim 9, wherein the components comprise an optical transducer with an optoelectronic component, as well as a lens unit extending above the optoelectronic component and including a lens carrier and at least one lens.

13. The sensor according to claim 9, wherein at least one mechanical component is constructed on the printed circuit board as an attachment element.

14. The sensor according to claim 9, wherein additional alignment pins are provided on the molded body for the exact positioning of the sensor.

15. The sensor according to claim 13, wherein the attachment element comprises a threaded insert or a threaded sleeve.

16. The sensor according to claim 15, wherein an electrical connection is guided through the threaded sleeve.

17. The sensor according to claim 9, wherein the molded body is made from a transparent or semi-transparent plastic and a light-emitting diode is provided on the printed circuit board.
